(19) United States
(12) Patent Application Publication
(10) Pub. No.: US 2022/0297040 A1
(43) Pub. Date: Sep. 22, 2022

(54) PEELABLE FILTERS PERMITTING DAMAGE FREE REMOVAL

(71) Applicant: 3M INNOVATIVE PROPERTIES COMPANY, St. Paul, MN (US)

(72) Inventors: Jason E. Troutman, Minneapolis, MN (US); James K. Magargee, St. Paul, MN (US); Andrew C. Stansel, Woodbury, MN (US); Connor M. Pelletier-Sutton, Minneapolis, MN (US); Margaret M. Bonello, Minneapolis, MN (US)

(21) Appl. No.: 17/634,467

(22) PCT Filed: Aug. 11, 2020
(86) PCT No.: PCT/IB2020/057550

§ 371 Date: Feb. 10, 2022

Related U.S. Application Data
(60) Provisional application No. 62/886,068, filed on Aug. 13, 2019.

(51) Int. Cl. B01D 46/00; B01D 39/08

(52) U.S. Cl. CPC B01D 46/0005; B01D 39/08; B01D 46/0032; B01D 2239/0435; B01D 2239/065

(57) ABSTRACT

The present disclosure provides filters that can be removed from surfaces without damage by having reduced or eliminated contribution of a core backing to peel force generated by the adhesive during removal. In some instances, this can be accomplished by a core that loses structural integrity in a direction normal to a plane defined by a major surface. In other instances, the contribution is reduced by compromising the interface between the core and a peelable adhesive layer.

### TECHNICAL FIELD

The present disclosure generally relates to peelable filters that are capable of attaching or adhering to a substrate in an airflow and that can be removed from the substrate without causing damage to the substrate. The present disclosure also generally relates to methods of making and using such filters.

### SUMMARY

Consumers and organizations are increasingly becoming aware of the importance of the quality of the air used for respiration. The typical person is exposed to multiple interior airflows per day, whether it be powered air handling systems of homes, offices, businesses, and motor vehicles or more passive air flow through a window or fan. The need exists for an easily deployed filter to assist the global population in affecting the quality of interior air. Such a filter would ideally form a secure bond on a barrier surface within a given air flow and be easy to remove once it reaches the end of its useful life.

Existing removal adhesive filtration products often do not work well on various surfaces, including, for example, irregular or discontinuous surfaces (e.g., outlet registers, vents, fan grates, etc.). Additionally, the existing adhesive filter products can sacrifice filtration performance to improve adhesion, or require the As such, the inventors of the present disclosure sought to formulate peelable filters with at least one of higher shear strength, ability to adhere to irregular and discontinuous surfaces, and/or that are capable of consistently filtering air, all without damaging the substrate to which they are applied.

The inventors of the present disclosure recognized that the existing air filtration products could be improved or enhanced by making modular, adhesive coated filter materials that can be cut to a desired size and applied to a number of surfaces. Such filter may be removed easily form surfaces without substantial damage. In some instances, this can be accomplished by ensuring the filter media loses structural integrity in a direction normal to a plane defined by a major surface thereof. In other instances, the contribution is reduced by compromising the interface between the filter media and a peelable adhesive layer. By separating the peel force from characteristics of the filter media, the filters of the present disclosure can capitalize on myriad materials and constructions without deleteriously impacting damage free removability or filtration performance. In some embodiments, the enhanced removability and conformability increases or enhances the product performance on certain surfaces (e.g., rough, textured surfaces, or irregular surfaces such as, for example, vents, dashboards, fan grates, etc.)

In one aspect, the present disclosure provides a filter comprising a first peelable adhesive layer and a discrete core of filter media defining a core plane.

In another aspect, the present disclosure provides a filter for mounting to a surface, the filter comprising: a first adhesive layer; a core adjacent the first adhesive layer and defining a perimeter, the core comprising filter media and including first and second major surfaces; and a first arranged pattern of recesses on at least the first major surface of the core, each recess terminating in a membrane comprising filter media; and an adhesive interface at the bottom wall surface, wherein the adhesive interface comprises contact between the first adhesive layer and the membrane.

In another aspect, the present disclosure provides a method for making a filter, the method comprising: providing a core having first and second opposing major surfaces and including a consolidatable filter material; laminating a peelable adhesive on at least one of the major surfaces; and consolidating a plurality of discrete regions of the material to form an arranged pattern of recesses; and creating a plurality of adhesive interfaces between the peelable adhesive and each consolidated region of the backing. In some embodiments, the consolidating occurs through ultrasonic point bonding. In another aspect, the backing is provided having a first arranged pattern of recesses, and the consolidation creates a second pattern of recesses.

In yet another aspect, the present disclosure provides a filter for mounting to a surface, the article comprising: a first adhesive layer comprising a first peelable adhesive composition: a core adjacent the first adhesive layer and defining a perimeter, the core comprising porous filter media and including first and second major surfaces; and a first arranged pattern of recesses on at least the first major surface of the core, each recess terminating in a membrane comprising core material, wherein the first peelable adhesive composition is at least partially within the pores of each membrane.

As used herein, “porosity” means a measure of void spaces in a material. Size, frequency, number, and/or interconnectivity of pores and voids contribute the porosity of a material.

As used herein, “void volume” means a percentage or fractional value for the unfilled space within a porous or fibrous body, such as a web or filter, which may be calculated by measuring the weight and volume of a web or filter, then comparing the weight to the theoretical weight of a solid mass of the same constituent material of that same volume.

As used herein, “Solidity” describes a dimensionless fraction (usually reported in percent) that represents the proportion of the total volume of a nonwoven web that is occupied by the solid (e.g., polymeric filament) material. Loft is 100% minus Solidity and represents the proportion of the total volume of the web that is unoccupied by solid material.

As used herein, “layer” means a single stratum that may be continuous or discontinuous over a surface.

As used herein, the terms, “height”, “depth”, “top” and “bottom” are for illustrative purposes only, and do not necessarily define the orientation or the relationship between the surface and the intrusive feature. Accordingly, the terms “height” and “depth”, as well as “top” and “bottom” should be considered interchangeable.

The terms “comprises” and variations thereof do not have a limiting meaning where these terms appear in the description and claims.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As recited herein, all numbers should be considered modified by the term “about”.

As used herein, “a”, “an”, “the”, “at least one”, and “one or more” are used interchangeably. Thus, for example, a core comprising “a” pattern of recesses can be interpreted as a core comprising “one or more” patterns.

Also herein, the recitations of numerical ranges by endpoints include all numbers subsumed within that range (e.g., 1 to 5 includes 1, 1.5, 2, 2.75, 3, 3.80, 4, 5, etc.).

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties). The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

The above summary of the present disclosure is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exhaustive list.

### BRIEF DESCRIPTION OF DRAWINGS

FIG. 1 is a top plan view of one embodiment of an exemplary filter of the type generally described herein;

FIG. 2 is a cross-sectional view of the filter of FIG. 2;

FIG. 3 is a cross-sectional view of one embodiment of an exemplary filter of the type generally described herein;

FIG. 4 is a cross-sectional micrograph of a filter featuring an arranged pattern of recesses created by thermal embossing;

FIG. 5 is a cross-sectional micrograph of a filter featuring an arranged pattern of recesses created by ultrasonic welding;

FIG. 6 is a perspective view of a flat panel filter according to an embodiment of the present disclosure;

FIG. 7 is a top plan view of an expandable filter frame including a peelable filter of the present disclosure, with the frame in a closed state;

FIG. 8 is a top plan view of the filter of FIG. 8, with the frame in an expanded state;

FIG. 9 is a block diagram detailing a method of creating arranged patterns of recesses on one or more surfaces of a filter media core;

FIG. 10 is a photographic depiction of a peelable filter of the present disclosure applied to the cage of an oscillating fan;

FIG. 11 is a photographic depiction of a peelable filter of the present disclosure applied to an air conditioner; and

FIG. 12 is a photographic depiction of a peelable filter of the present disclosure applied to an outlet register of an interior HVAC system.

Layers in certain depicted embodiments are for illustrative purposes only and are not intended to absolutely define the thickness, relative or otherwise, or the absolute location of any component. While the above-identified figures set forth several embodiments of the disclosure other embodiments are also contemplated, as noted in the description. In all cases, this disclosure is presented by way of representation and not limitation. It should be understood that numerous other modifications and embodiments can be devised by those skilled in the art, which fall within the scope and spirit of the principles of the disclosure.

### DETAILED DESCRIPTION

Various embodiments and implementations will be described in detail. These embodiments should not be construed as limiting the scope of the present application in any manner, and changes and modifications may be made without departing from the spirit and scope of the inventions. Further, only some end uses have been discussed herein, but end uses not specifically described herein are included within the scope of the present application. As such, the scope of the present application should be determined by the claims.

The present disclosure generally relates to filters that can be removed from a substrate, wall, or surface (generally, an adherend) without damage. As used herein, the terms “without damage” and “damage-free” or the like means the filter can be separated from the substrate without causing visible damage to paints, coatings, resins, coverings, or the underlying substrate and/or leaving behind residue. Visible damage to the substrates can be in the form of, for example, scratching, tearing, delaminating, breaking, crumbling, straining, and the like to any layers of the substrate. Visible damage can also be discoloration, weakening, changes in gloss, changes in haze, or other changes in appearance of the substrate.

The filter includes (1) one or more peelable adhesive layers adjacent to (2) a discrete core of filter media. As used herein, the term “peelable” means that the filter can be removed from a substrate or surface by peeling at angle of between about 1° and about 180°. In some embodiments, the filter can be removed from a substrate or surface by peeling at angle of between 30° to 120°. In some embodiments, the filter can be removed from a substrate or surface by peeling at angle of at least about 35°.

During peel release removal, specified regions of the core and adhesive undergo delamination. In particular, the articles of the present disclosure feature destructible adhesive/core material interfaces offset from major surfaces, preventing force from easily transferring from the load introduced during peel removal to an adherend. The filters are thus specifically designed to mimic a “backingless” construction, where the core has little to no contribution to adhesive removal forces experienced by the adherend. The “backingless” construction provides a filter with a peel force that does not exceed the damage threshold on substrates including, for example, drywall, paint, glass, etc.

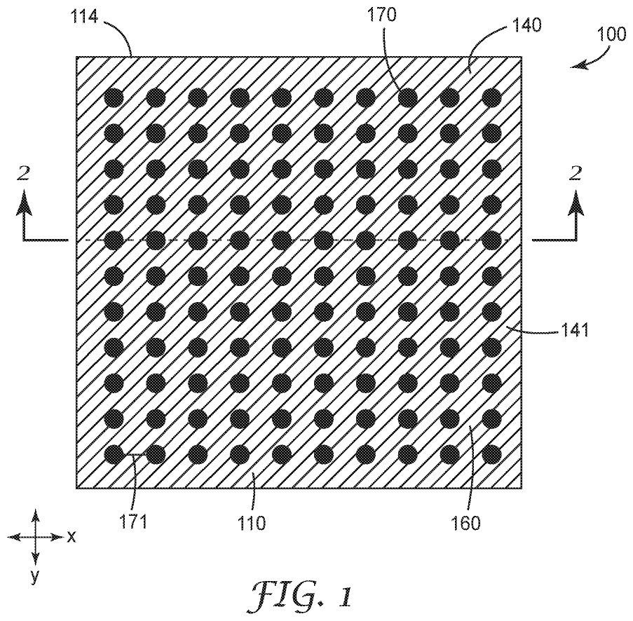

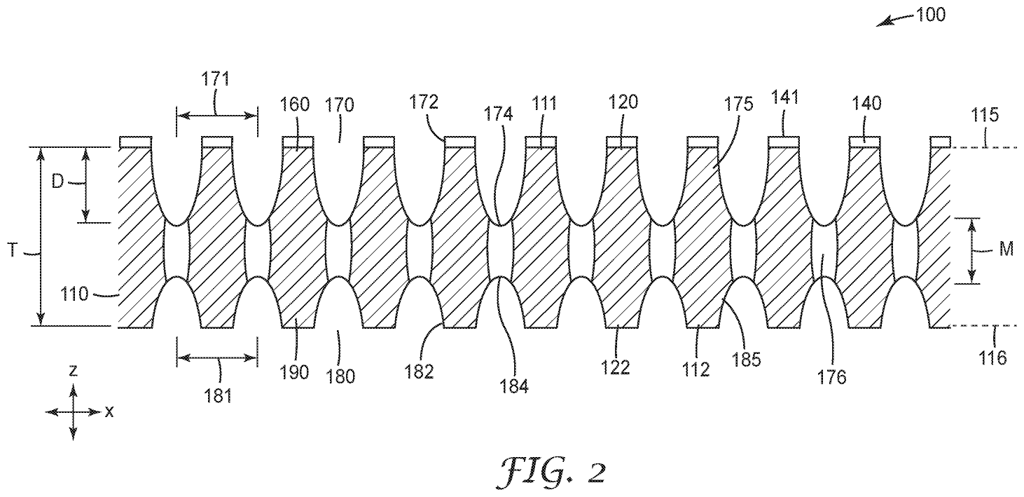

FIGS. 1 and 2 depict an exemplary embodiment of a filter 100 as generally described herein. The filter 100 includes a core 110 having first and second opposed major surfaces 111 and 112. FIG. 1 depicts the filter 100 in top plan view, with the core 110 visible through an adhesive layer 140. In some embodiments, the adhesive 140 can be generally optically clear such that the core is at least partially visible. In other embodiments, the adhesive layer 140 can be generally opaque or the core may be otherwise not visually identifiable in top plan view. As seen in FIG. 2, the core 110 has a square shape defined by an upper edge, a lower edge, and side edges. The shape of the core 110 is not particularly limited and can include any suitable shape or combination of shapes. The edges cooperate to form a core perimeter 114, which defines an identifiable boundary between the core and the remainder of the filter 100 (e.g., adhesive layer 140).

The core 110 exists as a distinct structural component of filter 100 and not as material dispersed or otherwise distributed in the adhesive layer 140. Materials forming filter core 110 can include a paper, natural or synthetic polymer films, nonwovens made from natural and/or synthetic fibers and combinations thereof, fabric reinforced polymer films, fiber or yarn reinforced polymer films or nonwovens, fabrics such as woven fabric formed of threads of synthetic or natural materials such as cotton, nylon, rayon, glass, ceramic materials, and the like, or combinations of any of these materials. In typical embodiments, the core is suitable for use as air filtration media, as described below. The core 110 may also be formed of metal, metallized polymer films, or ceramic sheet materials in combination with at least one of the above. In some embodiments, the core is a multilayered film having two or more layers; in some such embodiments the layers are laminated. Exemplary materials and constructions for the core 110 are explored in further detail below. Combinations of two or more such compositions and constructions are also useful in various embodiments of the present disclosure.

In the specific embodiment of FIGS. 1 & 2, the filter core 110 includes a single core layer of material having a thickness “T”, though multilayer or multi-material constructions are also contemplated and described herein. In some embodiments, the core has a thickness “T” of between about 2 mils and about 100 mils. In some embodiments, the core has a thickness of greater than 2 mils, greater than 5 mils, greater than 8 mils, greater than 10 mils, greater than 12 mils, greater than 15 mils, greater than 20 mils, greater than 22 mils, or greater than 24 mils. In some embodiments, the core has a thickness of less than 100 mils, less than 90 mils, less than 80 mils, less than 75 mils, less than 70 mils, less than 65 mils, less than 60 mils, less than 55 mils, less than 50 mils, less than 45 mils, less than 40 mils, less than 38 mils, less than 35 mils, less than 32 mils, less than 30 mils, less than 28 mils, or less than 25 mils.

As depicted in of FIG. 2, the core 110 is generally rectangular in cross-section, however the core may have a variety of cross-sectional shapes. For example, the cross-sectional shape of the core 110 may be a polygon (e.g., square, tetrahedron, rhombus, trapezoid), which may be a regular polygon or not, or the cross-sectional shape of the core 110 can be curved (e.g., round or elliptical). A first core plane 115 is coincident with the first major surface 111, while a second core plane 116 is coincident with the second major surface 112. The core planes 115, 116 are depicted in parallel, but may intersect and form an oblique angle in other embodiments.

The first major surfaces 111 is adjacent to a peelable adhesive layers 140. Though not depicted in FIG. 1, the second major surface may also be adjacent to a peelable adhesive layer. Peelable adhesive layers, in such embodiments, be the same as one another or disparate from one another. Disparate, in this context, is used to describe substantial differences in composition or adhesive performance. Adhesive layers can each be a single layer or can be multilayer. Adhesive layers can each be continuous or discontinuous (e.g., patterned) across the major surfaces of the core 110. An available bond area for the article includes by the total area defined by opposed major surfaces of any adhesive layer on the major surfaces 111, 112 of the filter core 110. In embodiments featuring recesses as detailed herein, the available bond area will not include the recesses. The available bond areas of the major surfaces 141, 145 are used to couple the filter 100 to, for example, a vent, a fan, or a frame.

The adhesive layer 140, as depicted, are no more than coextensive with the major surfaces 111, 112 of the core and are separated by the thickness “T”. The core 110 is thus discrete from the adhesive layer 140 and includes a defined and identifiable geometry, as described above. In other embodiments not depicted, the filter includes opposing adhesive layers on the first and second surfaces of the filtration core that are in contact in areas surrounding the perimeter of the core 110. Such constructions are described in detail in International Publication No. WO/2019/040862 (Krull et al.). The thickness of the adhesive layer(s) is not particularly limited, but is typically substantially continuous across at least the major surfaces of the core. In presently preferred implementations, the thickness of the adhesive layer is no greater than 95% of the core thickness “T”, no greater than 90%, no greater than 80%, no greater than 75%, no greater than 60%, no greater than 50%, no greater than 40%, no greater than 30%, no greater than 20%, and in some embodiments no greater than 10% of the core thickness “T”. In typical embodiments, one or both adhesive layers 140, 142 have a thickness of between about 1 mil and about 3 mils. The thickness of a given adhesive layer 140, 142 may be different from the other or the same.

The core 110 includes an array of recesses 170 on the first major surface 111 and an array of recesses 180 on the second major surface 112. Recesses, for example, can include wells, cavities, concavities, pockets, channels, and the like. Recesses 170, 180 can have a volume with dimensions such as diameter, radius, depth, length, and width. A base of the recess can generally refer to a location within the recessed feature having points lying closest to an average elevation of a major surface, while the surface or region of the recess farthest from the average elevation is considered an apex or bottom surface. In certain embodiments, particularly those lacking a second opposing adhesive layer, the second major surface may lack recesses.

In some embodiments and as depicted in FIGS. 1-2, the core 110 includes an arranged pattern of recesses 170, 180. An “arranged pattern” is a plurality of features (e.g., recesses, channels, etc.) arranged at predetermined positions, arranged with some degree of regularity, or arranged in any desired manner. The recesses 170, 180 in core 110 are each arranged in a grid array, but other patterns and arrangements are possible. In some embodiments, one or both recesses 170, 180 are distributed as a periodic array across a core surface (e.g., a one-dimensional array or a two-dimensional array, for example a square array, hexagonal, or other regular array). For example, the arranged pattern of recesses can include an arranged row pattern, an arranged lattice pattern such as an arranged square lattice pattern, an arranged zigzag pattern, or an arranged radial pattern. The arranged pattern need not be formed evenly on the entire surface but may be formed in only a portion of a given major surface. The pattern of recesses may vary or remain the same over any portion of the article. For example, similar or different patterns can be used within the same plane. The recesses within the pattern can be of similar geometry or can have different geometries. Similarly, the pattern of recesses 170 on the first major surface 111 may be the same or different than the corresponding pattern of recesses 180 on the second major surface. In certain implementations, the patterns on the first and second major surfaces 111, 112 may have substantially the same pitch and recess geometry, but are offset in the transverse or longitudinal direction, as described below.

In one exemplary construction, the arranged pattern of features includes both an array of discrete recesses (e.g., wells) and a series of channels extending between and/or through individual wells.

A Cartesian x-y-z coordinate system is included in FIGS. 1 & 2 for reference purposes. The first and second major surfaces 111, 112 extend generally parallel to the x-y plane, and the thickness “T” of the core 110 corresponds to the z-axis. Each array of recesses 170, 180 includes a transverse direction, generally along the x-axis and a longitudinal direction, generally along the y-axis. The arranged patterns include a defined pitch 171, 181 between nearest-neighboring, adjacent recesses 170, 180. The pitch between nearest-neighboring, adjacent recesses 170, 180 in an array or pattern may be the same in both the transverse direction and longitudinal direction. In other embodiments, the pitch along the transverse direction is less than the pitch along the longitudinal direction, and vice versa. The configuration of recesses in any given region can be chosen so that the pitch is at least, 0.25 millimeters, at least 0.5 millimeters, in other embodiments at least 15 millimeters, in other embodiments at least 20 millimeters, in other embodiments at least 25 millimeters, and in yet other embodiments at least 30 millimeters. In certain embodiments, the pitch is no greater than 70 millimeters, in some embodiments no greater than 60 millimeters, in some embodiments no greater than 50 millimeters, and in certain embodiments no greater than 45 millimeters.

The arranged pattern of recesses may result in a particular density of recesses 170, 180 per square centimeter. For example, the recesses can appear as discrete features in a sea of core material, or may encompass the majority of the core surface such that the core appears as a mesh or scrim. In some implementations, a major surface comprises at least 50 recesses per square centimeter, in some embodiments at least 100 recesses per square centimeter, in some embodiments, at least 200, and in yet other embodiments at least 300 microstructures per square centimeter. The core may comprise no greater than 2000 recesses per square centimeter, in some embodiments no greater than 1500, in some embodiments no greater than 1000, in some embodiments no greater than 750, and in other embodiments no greater than 500 recesses/cm². Under certain circumstances, a greater density of recesses requires a higher peel force to initiate internal delamination where desired.

The recesses 170, 180 can take the form of any shape. Similarly, the three-dimensional geometry of the recesses 170, 180 is not particularly limited so long as the recess does not extend through the thickness of the core to the opposing major surface. The illustrated embodiment of the core 110 comprises a plurality of circular recess bases 172, 182. Non-limiting examples of shapes that are suitable for recess bases 172, 182 include circles, triangles, squares, rectangles, and other polygons. The three-dimensional geometry of the recesses 170, 180 can include circular cylindrical; elliptical cylindrical; cuboidal (e.g., square cube or rectangular cuboid); conical; truncated conical and the like.

Regardless of cross-sectional shape, each recess 170, 180 comprises a largest cross-sectional dimension at the base 172, 182 and/or the bottom surface 174, 184. The size of the largest cross-sectional dimension is not particularly limited, but is typically at least 0.5 millimeters. A recess 170, 180 typically includes a depth “D” inversely related to the thickness “M” of the membrane 176. A relatively thicker membrane will result in shallower recess depth. It may be noted, however, that not all recesses of the plurality of recesses need fall within the depth range listed above.

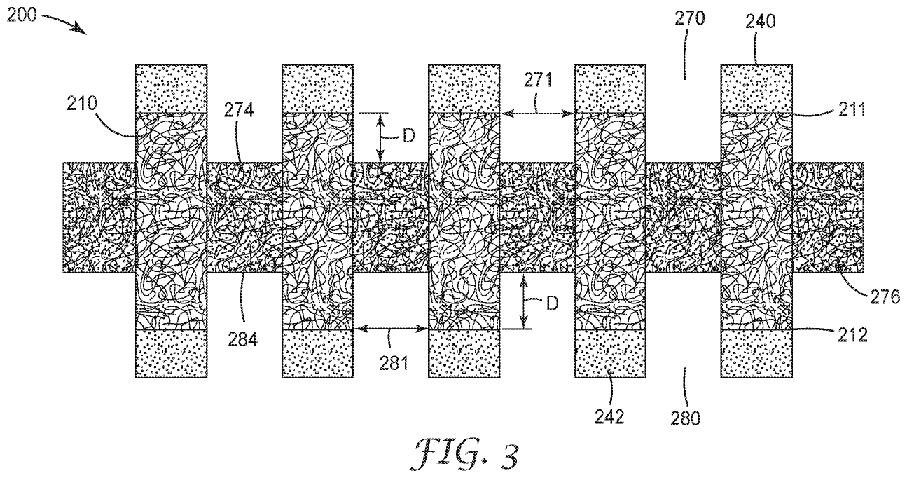

As depicted, the recesses 170, 180 are discrete along both the transverse and longitudinal directions. In other embodiments, one or both recesses 170, 180 can be discrete along one direction, such that the apertures resemble channels in the core, or may extend diagonally (relative to the orientation shown in FIG. 1) across one or both the major surfaces 111, 112 of the filter core. Such channels can follow any desired path and can be continuous or discontinuous across a surface of the core in any given direction. Exemplary arranged patterns, some including channels may be found in FIGS. 3A-3X of International Publication No. WO2019040820 (Krull et al.).

The recesses 170, 180 are essentially discreet and the core 110 includes interstitial spaces 160, 190 between adjacent recesses 170, 180, respectively. The interstitial space 160, 190 is, in the depicted implementation, un-patterned in that it generally lacks any additional hierarchical features. Accordingly, the sum area of the interstitial spaces 160, 190 defines the un-patterned regions on the first major surface 111 and second major surface 112, respectively.

The recesses 170, 180 on each of the first major surface 111 and second major surface 112 each have substantially the same geometry. In other embodiments, the size or shape of the recesses 170, 180 may change across the transverse direction, longitudinal direction, or combinations thereof. In yet other embodiments, a major surface can include two or more recesses of different geometries arranged in repeating unit cell. The unit cell can be repeated in an arranged pattern of unit cells. A variety of shapes may be used to define the unit cell, including rectangles, circles, half-circles, ellipses, half-ellipses, triangles, trapezoids, and other polygons (e.g., pentagons, hexagons, octagons), etc., and combinations thereof. In such embodiments, each unit cell boundary is directly adjacent the boundary of a neighboring unit cell, so that the plurality of unit cells resembles, e.g., a grid or tessellation.

Each recess 170, 180 extends a certain depth “D” into the thickness of the core 110 from respective major surface 111, 112. Generally, recesses comprise a base 172, 182 adjacent and substantially coplanar with a major surface and a bottom surface 174, 184 separated from base 172, 182 by the depth “D”. The core adjacent the bottom surface 174, 184 defines a relatively thin membrane 176 of core material.

The membranes 176 separate recesses 170 on the first major surface 111 from portions or all of recesses 180 on the second major surface 112. Any given collection of membranes can extend along the same plane within the core 110, such that the depth D is substantially the same for all recesses within the arrangement on one or both of the major surfaces 111, 112. In alternative implementations, the location of the membrane 176 in the z-direction within the core 110 varies along the transverse direction, the longitudinal direction, or both.

The membrane 176 separates the adhesive layer 140 across each recess 170, 180. Recess 170 thus includes a core-adhesive interface on the bottom surface 174, one or more sidewalls 175, or combinations thereof. This core-adhesive interface is hereinafter referred to as a recess interface. The membrane 176 typically has a thickness “M” of at least about 5% of the thickness “T” of the core, and in other embodiments at least about 10% of the thickness of the core. In the same or other embodiments, the thickness “M” is no greater than 95% of the thickness of the core 110. In embodiments featuring a nonwoven core, the thickness of the membrane is typically correlated with the porosity of the given nonwoven material(s). Under certain circumstances and constructions described herein and without wishing to be bound by theory, the structural integrity of the core can be more easily compromised upon peel removal with relatively thinner membranes 176 throughout the body of core 110.

In embodiments featuring a porous core material (e.g., nonwoven fabric), the membrane 176 typically possesses a lower porosity than the core in the non-recessed/unpatterned areas 160, 190. In some embodiments, the void volume (or porosity) of the membrane is no greater than 50 percent, no greater than 40 percent, no greater than 30 percent, no greater than 20 percent, and in some other embodiments no greater than 10 percent the porosity of the non-recessed area.

Contact between the first adhesive layer 140 and the interstitial spaces 160 defines a second core interface 120. Similarly, contact between the second adhesive layer 142 and the interstitial spaces 190 on the second major surface 112 defines a third core interface 122 opposing the second core interface 120. In some embodiments, the second and third interfaces 120, 122 include an area of adhesive contact with the core of at least about 5%; at least about 10%, at least about 25%; at least about 30%; at least about 35%; at least about 40%; at least about 45%; at least about 50%; at least about 55%; at least about 60%; at least about 65%; at least about 70%; at least about 75%; or at least about 80%. In some embodiments, the second and third core interfaces include an area of adhesive contact between the adhesive layer 140, 142 and the core of between about 10% and about 100%. In some embodiments, the second and third core interfaces 120, 122 include an area of adhesive contact between the adhesive layer 140, 142 and the core of between about 40% and about 90%. In embodiments featuring an adhesive layer on the second major surface 112, contact between the second adhesive layer and the interstitial spaces 190 on the second major will define a third core interface opposing the second core interface 120 having the same considerations as second core interface 120 explored above. The area of adhesive contact for each second and third core interface may be the same or different. In typical embodiments, the adhesive layers do not occupy all available volume within a given aperture.

The materials making up the core 110 and adhesive layer(s), as well as the construction of the filter, can be selected so that the bond at the recess interfaces is stronger than: 1) the bond strength at or near the first and/or second core interfaces; 2) the structural integrity (e.g., cohesive strength) of the core 110 in a direction substantially perpendicular to the core plane 115 or 3) combinations thereof.

The relationship between the recess interface and the core interfaces can be expressed as a Peel Ratio, which is defined as the peel strength (oz/in²) at the recess interfaces compared to the peel strength at the core interface(s). In some embodiments, the Peel Ratio can be at least 1.15:1; in some embodiments at least 1.25:1; in some embodiments at least 1.5:1; in some embodiments at least 2:1; in some embodiments at least 3:1; in some embodiments at least 5:1; in some embodiments at least 10:1; in some embodiments at least 15:1; in some embodiments at least 20:1.

The recesses 170, 180 can be created in a core material before, during, or after an adhesive layer has been applied to a major surface. The recesses 170 can be created by a combination of force and thermal/fusion energy, such as ultrasonic welding (or bonding), thermal contact welding, and/or point welding to reduce the thickness (i.e., consolidate) of core material. In implementations featuring a nonwoven or other porous core material, the creation of recesses 170, 180 can condense the core material by reducing porosity and/or causing core material to flow into regions of the core adjacent the bonding site. In certain implementations of the embodiment in FIGS. 1-2, the recesses are created by ultrasonic point bonding of the adhesive layer and the core according to an arranged pattern. Point bonding may also occur by, for example, by passing the core and the adhesive layer(s) through a heated patterned embossing roll nip. The point bonding creates an intermittent bond between the adhesive and core, condensing a portion of both the peelable adhesive and core material into the depths of individual recesses. In other embodiments, the desired pattern (including one or multiple patterns) may be created in the core prior to application of the adhesive layer. In yet other embodiments, multiple patterns may be created in the core, one or more prior to application of the adhesive layer and one or more after application of the adhesive layer.

Ultrasonic welding (or bonding) generally refers to a process performed, for example, by passing the requisite layers of material between a sonic horn and a patterned roll (e.g., anvil roll). Such bonding methods are well-known in the art. For instance, ultrasonic welding through the use of a stationary horn and a rotating patterned anvil roll is described in U.S. Pat. No. 3,844,869 (Rust Jr.); and U.S. Pat. No. 4,259,399 (Hill). Moreover, ultrasonic welding through the use of a rotary horn with a rotating patterned anvil roll is described in U.S. Pat. No. 5,096,532 (Neuwirth, et al.); U.S. Pat. No. 5,110,403 (Ehlert); and U.S. Pat. No. 5,817,199, (Brennecke, et al.). Of course, any other ultrasonic welding technique may also be used in the present invention.

In embodiments featuring a non-woven core, the intermittent bonding of the adhesive to the nonwoven fabric or web (e.g., using at least one of heat, pressure, or ultrasonics as described above) to create recesses can collapse (i.e., condense or consolidate) porous structure at or in the bond sites, resulting in the creation of membranes 176. The bond sites may be see-through regions of lower porosity that contrast with the surrounding region. The term “see-through” refers to either transparent (that is, allowing passage of light and permitting a clear view of objects beyond) or translucent (that is, allowing passage of light and not permitting a clear view of objects beyond). The see-through region may be colored or colorless. It should be understood that a “see-through” region is large enough to be seen by the naked eye.

In certain embodiments, the material for the core 110 is selected so that it forms a relative weak bond with either adhesive layer.

In other embodiments, the material or construction of the core is selected so that it delaminates, fails cohesively, or otherwise separates upon application of force generated on the filter during removal.

Even in embodiments featuring a destructible core, the core 110 can still provide sufficient strength along the general plane of its separation so that, depending on the specific application, the structural integrity of the core will not fail based on the use of the filter 100 for air filtration. The core 110 can advantageously provide an internal static shear strength in a direction parallel to the core planes 115, 116 sufficient for supporting an object and providing a level of resiliency to the article 100.

Another exemplary embodiment of a filter 200 is depicted in FIG. 3. Except as otherwise noted, all other considerations regarding the filter 100 apply equally to filter 200. Like the filter of FIGS. 1 and 2, the filter 200 includes a core 210, a first peelable adhesive layer 240 on a first major surface 211 of the core 210. The filter 200 includes a second peelable adhesive layer 242 on a second major surface 212 of the core 210. The core 210 is comprised of one or more porous filter materials and typically includes a nonwoven web.

The core 210 includes an arranged pattern of recesses 270, 280 on the first major surfaces 211 and second major surface 212, respectively, extending to a depth “D” within the core material. The recesses 270, 280 are typically arranged in the same pattern, with each opposing recess possessing substantially the same geometry. In certain implementations, the recesses 280 on the second major surfaces may be smaller at the base 281 than those on the first major surface 270.

The core 210 adjacent the bottom surface 274, 284 defines a relatively thin membrane 276 of core material. The membranes 276 separate recesses 270 on the first major surface 211 from portions or all of recesses 280 on the second major surface 212. Any given collection of membranes can extend along the same plane within the core 210, such that the depth D is substantially the same for all recesses within the arrangement on one or both of the major surfaces 211, 212. In alternative implementations, the location of the membrane 276 in the z-direction within the core 210 varies along the transverse direction, the longitudinal direction, or both.

Unlike membrane 176, the membrane 276 is at least partially infused with adhesive. In certain presently preferred embodiments, a filter includes a peelable adhesive composition at least partially within the pores of a porous core. For such embodiments, at least 40 volume %, at least 50 volume %, at least 60 volume %, at least 70 volume %, at least 80 volume %, preferably at least 90 volume %, and more preferably 100 volume % of the void volume is filled with the peelable adhesive composition. The amount of adhesive within the pores will depend on, among other things, the modulus of the adhesive, the method used to create the recesses, the thickness of the core, and the porosity of the core material. One skilled in the art will appreciate that the at least partial infusion may occur in embodiments having a single adhesive layer and/or an arrangement of recesses on only the first major surface of the core.

Depending on the degree of infiltration of the membrane voids, at least some of the bottom walls 274, 284 and sidewalls 273, 283 of the recesses 270, 280 may include a thin adhesive layer (not shown).

The embodiment of FIG. 3 may be created by methods described above. In presently preferred implementations, the core 210 is pattern embossed, according to procedures well known in the art, such as those described in U.S. Pat. Nos. 2,464,301 (Francis Jr.), 3,507,943 (Such et al.), 3,737,368 (Such et al.), and 6,383,958 (Swanson et al) and set forth in more detail below. In general, the core and adhesive layer(s) are passed through a metal roll that is patterned (e.g., engraved) with raised and depressed areas, and a solid back-up roll, generally formed of metal or rubber. However, the core can also be fed between two patterned rolls displaying corresponding or alternating engraved areas. In either case, it is typical to supply heat to one or more of the rolls so that the core is thermally bonded along the points of pattern contact.

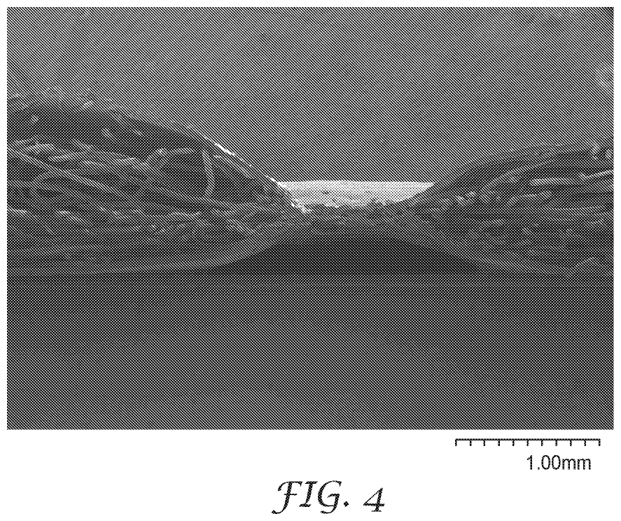

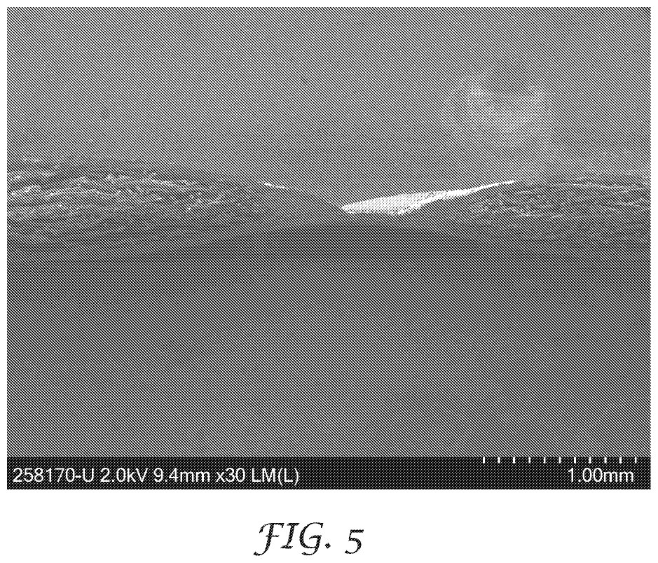

While not wishing to be bound by any particular theory, it is believed that the recesses in the embossed pattern are formed by localized melting of the core in the pattern of the raised areas on the patterned embossing roll. The core is not destroyed by the process but, instead, maintains its integrity. Moreover, the heat from the one or more rolls causes the adhesive to flow into at least some of the voids in the core prior to and/or contemporaneous with the creation the recesses through contact pressure, as can be seen in FIG. 5. Typically, the majority of the adhesive will remain within membrane voids, though some volume may flow into the surrounding core as well. As used herein, “embossed pattern” refers to a predetermined configuration of recesses on a surface of the core. An embossed pattern is distinguishable from a “perforated” pattern, which refers to a predetermined configuration of punctures that pass through the entire thickness of the core. For instance, an array of recesses created through heated pattern embossing an adhesive laminated nonwoven will typically include a greater amount of adhesive within the voids in comparison to the same pattern created through ultrasonic welding.

Under certain conditions, the use of ultrasonic welding can result in little to no adhesive infused in the membrane, with core material itself instead infused into the adjacent voids.

When an array of recesses is created by pattern embossing, the degree of reduction in void volume due to consolidation or densification in a given membrane may be reduced relative to the consolidation resulting from ultrasonic welding. In some embodiments featuring an embossed pattern(s), the void volume (or porosity) of the membrane is no greater than 90 percent, no greater than 70 percent, no greater than 60 percent, no greater than 50 percent, and in some other embodiments no greater than 40 percent the porosity of the non-recessed area of the core.

The filters of the present disclosure include available bond areas defined by the total area of the unpatterned region of the core (i.e., the area within each recess (aperture or channel) is excluded from the bond area calculation, since the adhesive within the depths of the recesses will not typically contribute as much to the bond of the article to the desired adherend). In some embodiments, the available bond area of the article is at least about 5%; at least about 10%, at least about 25%; at least about 30%; at least about 35%; at least about 40%; at least about 45%; at least about 50%; at least about 55%; at least about 60%; at least about 65%; at least about 70%; at least about 75%; or at least about 80% of an expected surface area of a core material including like dimensions and lacking recesses. In some embodiments, the articles include an available bond area of between about 10% and about 90%. In yet other embodiments, the articles include an available bond area of between about 15% and about 70% of an expected surface area of a core material including like dimensions and lacking recesses.

Constituent elements of the filters described herein are explored in more detail below.

Core—Filter Media

The particular filter media used as the core is not critical to the present disclosure so long as the resultant air filter has the desired filtration characteristics.

The core is part of the adhesive construction and interferes with the interfacial bonding of portions of otherwise adjacent adhesive layers. The core can be a single layer or a multilayer construction. More than one core layer can be present in the core. Multiple core layers can be separated by layers of film, which may further contain one or more layers. In some embodiments, the core includes at least one of plastic, metal, paper, nonwoven material, textile, woven material, foam, adhesive, gel, and/or a filament reinforced material. In other embodiments, the core can be an arrangement of particles disposed between adjacent adhesive layers.

In some embodiments, two or more sub-layers can be co-extruded so as to form the core. In some embodiments, the core is flexible. Some embodiments include dyes or pigments in the core layer. Some embodiments include at least one tackifier in at least one layer of the core. Some embodiments include a plasticizing oil in one or more layers of the core.

The core can be any desired shape including, for example, square, rectangle, triangular, polygon, circular, quadrilateral, trapezoidal, cylindrical, half-circular, star-shaped, half-moon shaped, tetrahedral, etc.

The core can be made of any desired material or materials having filtration properties and acting as filter media.

The core can be substantially non-stretchable or can be elastic.

In some embodiments, the core has a thickness of between about 0.1 mils and about 100 mils. In some embodiments, the core has a thickness of greater than 1 mil, greater than 5 mils, greater than 8 mils, greater than 10 mils, greater than 12 mils, greater than 15 mils, greater than 20 mils, greater than 22 mils, or greater than 24 mils. In some embodiments, the core has a thickness of less than 100 mils, less than 90 mils, less than 80 mils, less than 75 mils, less than 70 mils, less than 65 mils, less than 60 mils, less than 55 mils, less than 50 mils, less than 45 mils, less than 40 mils, less than 38 mils, less than 35 mils, less than 32 mils, less than 30 mils, less than 28 mils, or less than 25 mils.

The filter media used in the core can be pleated or unpleated. In presently preferred embodiments of the present disclosure, the filter media used in the core is not pleated. The filter media associated with a flat, unpleated version of the filter can be formed of any of the materials described below, and is typically formatted to maintain a prescribed size and shape.

Though not typical, the optional pleats can be formed using various methods and components as are well known in the art, e.g., to form a pleated filter for use in applications such as air filtration., for example those described in U.S. Pat. No. 6,740,137 to Kubokawa et al. and U.S. Pat. No. 7,622,063 to Sundet et al., the entire teachings of both of which are incorporated herein by reference.

The filter media can be self-supporting or non-self-supporting. As used herein, the term “self-supporting” with respect to filter media describes filter media that satisfies at least one of the following conditions: (1) a filter media or web that is deformation resistant without requiring stiffening layers, adhesive or other reinforcement in the filter media web; or (2) the filter media generally maintains its shape when subjected to an airstream as described, for example, in U.S. Pat. No. 7,169,202 to Kubokawa, the entire teachings of which are incorporated herein by reference; or (3) a web or media having sufficient coherency and strength so as to be drapable and handleable without substantial tearing or rupture. Flat panel filter media may use wire and/or polyolefin netting. Some filter designs may use polyolefin strands versus adhesive strands to maintain pleat spacing. As used herein, the term “non-self-supporting” can denote a filter media that does not satisfy at least one of the above conditions.

The filter media (whether pleated or not) may be comprised of nearly any material, in any configuration, that is capable of filtering moving air. Such media may include, but is not limited to, fibrous materials (e.g., nonwoven webs, fiberglass webs, and so on), honeycomb structures loaded with filter media and/or sorbent material, and so on.

Filter media can be, for example, nonwoven fibrous media formed of, for example, thermoplastic or thermosetting materials such as polypropylene, linear polyethylene, and polyvinyl chloride; porous foams; nonwovens; paper; fiberglass; a high loft spunbonded web (such as described, for example, in U.S. Pat. No. 8,162,153 to Fox et al., the entire teachings of which are incorporated herein); a low loft spunbonded web (such as those described in U.S. Pat. No. 7,947,142 to Fox et al., the entire teachings of which are incorporated herein) or the like. In yet other embodiments, nonwoven webs useful with the filter media are generated by other techniques and/or have other characteristics, such as the meltblown nonwoven webs disclosed in U.S. Pat. No. 6,858,297 to Shah et al. (mentioned above). Other non-limiting example of useful nonwoven web formats include bi-modal fiber diameter meltblown media such as that described in U.S. Pat. No. 7,858,163 (Angadjivand et al.), the entire teaching of which are incorporated herein by reference. In various embodiments, nonwoven web may be, e.g., a carded web, an air-laid web or, a spun-laced web, and so on. In other embodiments, nonwoven web may be a multilayer web, e.g., a so-called spunbond-meltblown-spunbond (SMS) web or the like. The fibers of nonwoven web may be arranged (whether by bonding fibers to each other and/or physically entangling fibers with each other, or some combination thereof) to form, e.g., a handleable web by way of melt-bonding, adhesive bonding, needle-punching, stitch-bonding, and so on, as desired.

In some embodiments, the filter media comprises a nonwoven web that can have random fiber arrangement and generally isotropic in-plane physical properties (e.g., tensile strength), or, if desired, may have aligned fiber construction (e.g., one in which the fibers are aligned in the machine direction as described in U.S. Pat. No. 6,858,297 to Shah et al., the teachings of which are incorporated herein by reference) and anisotropic in-plane physical properties. Some or all of the fibers comprising the nonwoven webs useful with the filter media can be multicomponent fibers having at least a first region and a second region, where the first region has a melting temperature lower than the second region. Some suitable multicomponent fibers are described, for example, in U.S. Pat. Nos. 7,695,660 (Berrigan et al.), 6,057,256 (Krueger et al.), 5,597,645 (Pike et al.), 5,662,728 (Groeger), 5,972,808 and 5,486,410 (Groeger et al.), the teachings of each of which are incorporated herein by reference in their entireties. Further aspects of nonwoven webs are explored in more detail below.

An electrostatic charge can be optionally imparted into or on to material(s) of the filter media. Thus, the filter media can be an electret nonwoven web. Electric charge can be imparted to the filter media in a variety of ways as is well known in the art, for example by hydrocharging, corona charging, tribocharging, etc. (e.g., as described in U.S. Pat. No. 7,947,142 (mentioned above)). In other embodiments, the filter media is not electrostatically charged. Additives may also be included in the fibers to enhance the web's filtration performance, mechanical properties, aging properties, surface properties or other characteristics of interest. Representative additives include fillers, nucleating agents (e.g., MILLAD™ 3988 dibenzylidene sorbitol, commercially available from Milliken Chemical), UV stabilizers (e.g., CHIMASSORB™ 944 hindered amine light stabilizer, commercially available from Ciba Specialty Chemicals), cure initiators, stiffening agents (e.g., poly(4-methyl-1-pentene)), surface active agents and surface treatments (e.g., fluorine atom treatments to improve filtration performance in an oily mist environment as described in U.S. Pat. Nos. 6,398,847, 6,397,458, and 6,409,806 to Jones et al.). The types and amounts of such additives will be apparent to those skilled in the art.

In particular embodiments, the filter media may be a multilayer media that comprises at least one layer that includes an electret material, and at least one layer that includes a sorbent material. In some embodiments filter media 107 may comprise at least one layer capable of HEPA filtration. Electrostatically charged media may enhance particulate capture. Electrically charged media may be used in electrostatic precipitators which have a current and ground wire and are typically washable.

If at least one layer of the filter media is to exhibit sorbent functionality, any suitable sorbent(s), in any convenient physical form, may be included in such a layer. In particular embodiments, such a sorbent may be capable of capturing formaldehyde (formaldehyde is a very light gas which may not be captured by typical carbon filters. Many carbon filters capture much heavier gases such as urea, cooking odors, etc. These filters use activated carbons. To capture Formaldehyde and toluene gases, a treated (often acid treated) carbon may be used. In some embodiments, the sorbent includes at least some activated carbon. If desired, the activated carbon may be treated to enhance its ability to capture formaldehyde. Suitable treatments may e.g., provide the activated carbon with at least some amine functionality and/or at least some manganate functionality and/or at least some iodide functionality. Specific examples of treated activated carbons that may be suitable include those that have been treated with e.g., potassium permanganate, urea, urea/phosphoric acid, and/or potassium iodide. Other sorbents that may be potentially suitable e.g., for removing formaldehyde include e.g., treated zeolites and treated activated alumina. Such materials may be included e.g., along with treated activated carbon if desired.

The one or more sorbents may be provided in any usable form; for example, as particles, which may be e.g., powder, beads, flakes, whiskers, granules or agglomerates. The sorbent particle size may vary as desired. The sorbent particles may be incorporated into or onto a layer of filter media 107 in any desired fashion. For example, in various embodiments the sorbent particles may be physically entangled with fibers of a layer of filter media 107, may be adhesively bonded to such fibers, or some combination of both mechanisms may be used.

Nonwovens

In some presently preferred embodiments, the filter media includes a nonwoven substrate. The nonwoven substrate can be a nonwoven fabric or web manufactured by any of the commonly known processes for producing nonwoven fabric or webs. As used herein, the term “nonwoven” refers to a fabric that has a structure of individual fibers or filaments which are randomly and/or unidirectionally interlaid in a mat-like fashion, but not in an identifiable manner as in a knitted fabric. Nonwoven fabrics or webs can be formed from various processes such as meltblowing processes, spunbonding processes, spunlacing processes, and bonded carded web processes, air laying processes, and wet laying processes. In some embodiments, the core comprises multiple layers of nonwoven materials with, for example, at least one layer of a meltblown nonwoven and at least one layer of a spunbonded nonwoven, or any other suitable combination of nonwoven materials. For example, the core may be a spunbond-meltbond-spunbond, spunbond-spunbond, or spunbond-spunbond-spunbond multilayer material. Or, the core may be a composite web comprising a nonwoven layer and a film layer.

“Meltblowing”, as used herein, means a method for forming a nonwoven fibrous web by extruding a molten fiber-forming material through a plurality of orifices in a die to form fibers while contacting the fibers with air or other attenuating fluid to attenuate the fibers into fibers, and thereafter collecting the attenuated fibers. An exemplary meltblowing process is taught in, for example, U.S. Pat. No. 6,607,624 (Berrigan et al.). “Meltblown fibers” means fibers prepared by a meltblowing or meltblown process. “Spun-bonding” and “spun bond process” mean a method for forming a nonwoven fibrous web by extruding molten fiber-forming material as continuous or semi-continuous fibers from a plurality of fine capillaries of a spinneret, and thereafter collecting the attenuated fibers. An exemplary spun-bonding process is disclosed in, for example, U.S. Pat. No. 3,802,817 to Matsuki et al. “Spun bond fibers” and “spun-bonded fibers” mean fibers made using spun-bonding or a spun bond process. Such fibers are generally continuous fibers and are entangled or point bonded sufficiently to form a cohesive nonwoven fibrous web such that it is usually not possible to remove one complete spun bond fiber from a mass of such fibers. The fibers may also have shapes such as those described, for example, in U.S. Pat. No. 5,277,976 to Hogle et al, which describes fibers with unconventional shapes. “Carding” and “carding process” mean a method of forming a nonwoven fibrous web webs by processing staple fibers through a combing or carding unit, which separates or breaks apart and aligns the staple fibers in the machine direction to form a generally machine direction oriented fibrous nonwoven web. Exemplary carding processes and carding machines are taught in, for example, U.S. Pat. No. 5,114,787 to Chaplin et al. and U.S. Pat. No. 5,643,397. “Bonded carded web” refers to nonwoven fibrous web formed by a carding process wherein at least a portion of the fibers are bonded together by methods that include for example, thermal point bonding, autogenous bonding, hot air bonding, ultrasonic bonding, needle punching, calendering, application of a spray adhesive, and the like. Further details regarding the production and characteristics of nonwoven webs and laminates including nonwoven webs may be found, for example, in U.S. Pat. No. 9,469,091 (Henke et al.), which is incorporated by reference in its entirety herein. “Air-laying” refers to a process in which bundles of small fibers having typical lengths ranging from about 3 to about 52 millimeters (mm) are separated and entrained in an air supply and then deposited onto a forming screen, usually with the assistance of a vacuum supply. The randomly oriented fibers may then be bonded to one another using, for example, thermal point bonding, autogenous bonding, hot air bonding, needle punching, calendering, a spray adhesive, and the like. An exemplary air-laying process is taught in, for example, U.S. Pat. No. 4,640,810 to Laursen et al. “Wet-laying” refers to a is a process in which bundles of small fibers having typical lengths ranging from about 3 to about 52 millimeters (mm) are separated and entrained in a liquid supply and then deposited onto a forming screen, usually with the assistance of a vacuum supply. Water is typically the preferred liquid. The randomly deposited fibers may by further entangled (e.g., hydro-entangled), or may be bonded to one another using, for example, thermal point bonding, autogeneous bonding, hot air bonding, ultrasonic bonding, needle punching, calendering, application of a spray adhesive, and the like. An exemplary wet-laying and bonding process is taught in, for example, U.S. Pat. No. 5,167,765 to Nielsen et al. Exemplary bonding processes are also disclosed in, for example, U.S. Pat. No. 9,139,940 to Berrigan et al.

Fibrous materials that provide useful nonwoven cores may be made of natural fibers (e.g., wood or cotton fibers), synthetic fibers (e.g., thermoplastic fibers), or a combination of natural and synthetic fibers. Exemplary materials for forming thermoplastic fibers include polyolefins (e.g., polyethylene, polypropylene, polybutylene, ethylene copolymers, propylene copolymers, butylene copolymers, and copolymers and blends of these polymers), polyesters, and polyamides. The nonwoven substrate may be formed from fibers or filaments made of any suitable thermoplastic polymeric material. Suitable polymeric materials include, but are not limited to, polyolefins, poly(isoprenes), poly(butadienes), fluorinated polymers, chlorinated polymers, polyamides, polyimides, polyethers, poly(ether sulfones), poly(sulfones), poly(vinyl acetates), copolymers of vinyl acetate, such as poly(ethylene)-co-poly(vinyl alcohol), poly(phosphazenes), poly(vinyl esters), poly(vinyl ethers), poly(vinyl alcohols), and poly(carbonates). Suitable polyolefins include, but are not limited to, poly(ethylene), poly(propylene), poly(1-butene), copolymers of ethylene and propylene, alpha olefin copolymers (such as copolymers of ethylene or propylene with 1-butene, 1-hexene, 1-octene, and 1-decene), poly(ethylene-co-1-butene) and poly(ethylene-co-1-butene-co-1-hexene). Suitable fluorinated polymers include, but are not limited to, poly(vinyl fluoride), poly(vinylidene fluoride), copolymers of vinylidene fluoride (such as poly(vinylidene fluoride-co-hexafluoropropylene), and copolymers of chlorotrifluoroethylene (such as poly(ethylene-co-chlorotrifluoroethylene). Suitable polyamides include, but are not limited to: poly(iminoadipoyliminohexamethylene), poly(iminoadipoyliminodecamethylene), and polycaprolactam. Suitable polyimides include poly(pyromellitimide). Suitable poly(ether sulfones) include, but are not limited to, poly(diphenylether sulfone) and poly(diphenylsulfone-co-diphenylene oxide sulfone). Suitable copolymers of vinyl acetate include, but are not limited to, poly(ethylene-co-vinyl acetate) and such copolymers in which at least some of the acetate groups have been hydrolyzed to afford various poly(vinyl alcohols) including, poly(ethylene-co-vinyl alcohol).

The fibers may also be multi-component fibers, for example, having a core of one thermoplastic material and a sheath of another thermoplastic material. The sheath may melt at a lower temperature than the core, providing partial, random bonding between the fibers when the mat of fibers is exposed to a sheath melts. A combination of mono-component fibers having different melting points may also be useful for this purpose. In some embodiments, the nonwoven fabric or web useful in the core according to the present disclosure is at least partially elastic. Examples of polymers for making elastic fibers include thermoplastic elastomers such as ABA block copolymers, polyurethane elastomers, polyolefin elastomers (e.g., metallocene poly olefin elastomers), olefin block copolymers, polyamide elastomers, ethylene vinyl acetate elastomers, and polyester elastomers. An ABA block copolymer elastomer generally is one where the A blocks are polystyrenic, and the B blocks are prepared from conjugated dienes (e.g., lower alkylene dienes). The A block is generally formed predominantly of substituted (e.g., alkylated) or unsubstituted styrenic moieties (e.g., polystyrene, poly(alphamethylstyrene), or poly(t-butylstyrene)), having an average molecular weight from about 4,000 to 50,000 grams per mole. The B block(s) is generally formed predominantly of conjugated dienes (e.g., isoprene, 1,3-butadiene, or ethylene-butylene monomers), which may be substituted or unsubstituted, and has an average molecular weight from about 5,000 to 500,000 grams per mole. The A and B blocks may be configured, for example, in linear, radial, or star configurations. An ABA block copolymer may contain multiple A and/or B blocks, which blocks may be made from the same or different monomers. A typical block copolymer is a linear ABA block copolymer, where the A blocks may be the same or different, or a block copolymer having more than three blocks, predominantly terminating with A blocks. Multi-block copolymers may contain, for example, a certain proportion of AB diblock copolymer, which tends to form a more tacky elastomeric film segment. Other elastic polymers can be blended with block copolymer elastomers, and various elastic polymers may be blended to have varying degrees of elastic properties. Many types of thermoplastic elastomers are commercially available, including those from BASF, Florham Park, N.J., under the trade designation “STYROFLEX”, from Kraton Polymers, Houston, Tex., under the trade designation “KRATON”, from Dow Chemical, Midland, Mich., under the trade designation “PELLETHANE”, “INFUSE”, VERSIFY”, or “NORDEL”, from DSM, Heerlen, Netherlands, under the trade designation “ARNITEL”, from E.I. duPont de Nemours and Company, Wilmington, Del., under the trade designation “HYTREL”, from ExxonMobil, Irving, Tex. under the trade designation “VISTAMAXX”, and more.

For example, the fibrous nonwoven web can be made by carded, air laid, wet laid, spunlaced, spunbonding, electrospinning or melt-blowing techniques, such as melt-spun or melt-blown, or combinations thereof. Any of the non-woven webs may be made from a single type of fiber or two or more fibers that differ in the type of thermoplastic polymer, shape, and/or thickness; the single fiber type or at least one of the multiple fiber types may each be a multicomponent fiber as described above.

Staple fibers may also be present in the web. The presence of staple fibers generally provides a loftier, less dense web than a web of only melt blown microfibers. A loftier web may have reduced cohesive strength at the core interface or the in bulk of the core itself, leading to easier separation from one or more adhesive layers.

The nonwoven article may optionally further comprise one or more layers of scrim. For example, either or both major surfaces may each optionally further comprise a scrim layer. The scrim, which is typically a woven or nonwoven reinforcement made from fibers, is included to provide strength to the nonwoven article. Suitable scrim materials include, but are not limited to, nylon, polyester, fiberglass, polyethylene, polypropylene, and the like. The average thickness of the scrim can vary. The layer of the scrim may optionally be bonded to the nonwoven substrate. A variety of adhesive materials can be used to bond the scrim to the substrate. Alternatively, the scrim may be heat-bonded to the nonwoven.

Useful nonwoven cores may have any suitable EFD, basis weight or thickness that is desired for a particular application. “Effective Fiber Diameter” or “EFD” is the apparent diameter of the fibers in a fiber web based on an air permeation test in which air at 1 atmosphere and room temperature is passed through a web sample at a specified thickness and face velocity (typically 5.3 cm/sec), and the corresponding pressure drop is measured. Based on the measured pressure drop, the Effective Fiber Diameter is calculated as set forth in Davies, C. N., The Separation of Airborne Dust and Particulates, Institution of Mechanical Engineers, London Proceedings, IB (1952). The fibers of the nonwoven substrate typically have an effective fiber diameter of from at least 0.1, 1, 2, or even 4 micrometers and at most 125, 75, 50, 35, 25, 20, 15, 10, 8, or even 6 micrometers. Spunbond cores typically have an EFD of no greater than 35, while air-laid cores may have a larger EFD on the order of 100 microns. The nonwoven core preferably has a basis weight in the range of at least 5, 10, 20, or even 50 g/m²; and at most 800, 600, 400, 200, or even 100 g/m². Basis weight is calculated from the weight of a 10 cm×10 cm sample. The minimum tensile strength of the nonwoven web is about 4.0 Newtons in the machine direction. For embodiments featuring a membrane at least partially infused with an adhesive composition, a larger EFD (e.g., at least 45) available in an air-laid or bonded carded web may be desirable in certain circumstances. Without wishing to be bound by theory, the larger EFD and attendant high loft can allow for improved penetration of the adhesive through the filter media.

The loft of core nonwovens can also be characterized in terms of Solidity (as defined herein and as measured by methods reported herein). Solidity is determined by dividing the measured bulk density of a nonwoven fibrous web by the density of the materials making up the solid portion of the web. Bulk density of a web can be determined by first measuring the weight (e.g., of a 10-cm-by-10-cm section) of a web. Dividing the measured weight of the web by the web area provides the basis weight of the web, which is reported in g/m2. The thickness of the web can be measured by obtaining (e.g., by die cutting) a 135 mm diameter disk of the web and measuring the web thickness with a 230 g weight of 100 mm diameter centered atop the web. The bulk density of the web is determined by dividing the basis weight of the web by the thickness of the web and is reported as g/m3. The Solidity is then determined by dividing the bulk density of the nonwoven fibrous web by the density of the material (e.g., polymer) comprising the solid filaments of the web. The density of a bulk polymer can be measured by standard means if the supplier does not specify the material density.

Loft is usually reported as 100% minus the Solidity (e.g., a Solidity of 7% equates to a loft of 93%). A higher loft is particularly advantageous in pattern embossed cores, as the adhesive can infiltrate and flow throughout the void volume with greater relative ease during the application of thermal energy and/or pressure. As such, it may be desirable to couple a high loft nonwoven core with a pattern embossing process to create the requisite arrays of recesses.

As disclosed herein, webs of Solidity from about 2.0% to less than 12.0% (i.e., of loft of from about 98.0% to greater than 88.0%) can be produced. In various embodiments, webs as disclosed herein comprise a Solidity of at most about 7.5%, at most about 7.0%, or at most about 6.5%. In further embodiments, webs as disclosed herein comprise a Solidity of at least about 5.0%, at least about 5.5%, or at least about 6.0%.

Peelable Adhesive Layer(s)

The adhesives used in the filters described herein can include any adhesive having the desired properties. In some embodiments, the adhesive is peelable. In some embodiments, the adhesive releases cleanly from the surface of an adherend when the filter is peeled at an angle of about 35° or less from a surface of the adherend. In some embodiments, the peelable adhesive releases from a surface of an adherend when an article is peeled at an angle of about 35° or greater from the adherend surface such that there are substantially no traces of the adhesive left behind on the surface of the adherend.

The adhesive can be, for example, any of the adhesives described in any of the following patent applications, all of which are incorporated by reference herein: International Publication Nos. WO/2015/035556, WO/2015/035960, WO/2017/136219, WO/2017/136188 and U.S. Patent Application No. 2015/034104, all of which are incorporated herein in their entirety.

In some embodiments, the peelable adhesive is a pressure sensitive adhesive. Any suitable composition, material or ingredient can be used in the pressure sensitive adhesive. Exemplary pressure sensitive adhesives utilize one or more thermoplastic elastomers, e.g., in combination with one or more tackifying resins. A general description of useful pressure sensitive adhesives may be found in the Encyclopedia of Polymer Science and Engineering, Vol. 13, Wiley-Interscience Publishers (New York, 1988). Additional description of useful pressure-sensitive adhesives may be found in the Encyclopedia of Polymer Science and Technology, Vol. 1, Interscience Publishers (New York, 1964). Pressure sensitive adhesive compositions are well known to those of ordinary skill in the art to possess properties including the following: (1) tack, (2) adherence with no more than finger pressure, (3) sufficient ability to hold onto an adherend, and (4) sufficient cohesive strength to be cleanly removable from the adherend. Materials that have been found to function well as pressure sensitive adhesives are polymers designed and formulated to exhibit the requisite viscoelastic properties resulting in a desired balance of tack, peel adhesion, and shear holding power. Suitable PSAs may be based on crosslinked or non-crosslinked (meth)acrylics, rubbers, thermoplastic elastomers, silicones, polyurethanes, and the like, and may include tackifiers in order to provide the desired tac, as well as other additives. In some embodiments, the PSA is based on a (meth)acrylic PSA or at least one poly(meth)acrylate, where (meth)acrylate refers to both acrylate and methacrylate groups. In some embodiments, the PSA is an olefin block copolymer based adhesive. Acrylic based pressure sensitive adhesives are described in U.S. Pat. No. 4,726,982 (Traynor et al.) and in U.S. Pat. No. 5,965,256 (Barrera), for example. Silicone based pressure sensitive adhesives are described in U.S. Pat. No. 6,730,397 (Melancon et al.) and U.S. Pat. No. 5,082,706 (Tangney), for example. Polyurethane based pressure sensitive adhesives are described in U.S. Pat. Appl. Pub. No. 2005/0137375 (Hansen et al.), for example. Olefin block copolymer based pressure sensitive adhesives are described in U.S. Pat. Appl. Pub. No. 2014/0335299 (Wang et al.), for example. In some embodiments, the adhesive is not a pressure sensitive adhesive.

In some embodiments, the peelable adhesive layer can include at least one of rubber, silicone, or acrylic based adhesives. In some embodiments, the peelable adhesive layer can include a pressure-sensitive adhesive (PSA). In some embodiments, the peelable adhesive can include tackified rubber adhesives, such as natural rubber; olefins; silicones, such as silicone polyureas or silicone block copolymers; synthetic rubber adhesives such as polyisoprene, polybutadiene, and styrene-isoprene-styrene, styrene-ethylene-butylene-styrene and styrene-butadiene-styrene block copolymers, and other synthetic elastomers; and tackified or untackified acrylic adhesives such as copolymers of isooctylacrylate and acrylic acid, which can be polymerized by radiation, solution, suspension, or emulsion techniques; polyurethanes; silicone block copolymers; and combinations of the above.

Generally, any known additives useful in the formulation of adhesives may also be included. Additives include plasticizers, anti-aging agents, ultraviolet stabilizers, colorants, thermal stabilizers, anti-infective agents, fillers, crosslinkers, as well as mixtures and combinations thereof. In certain embodiments, the adhesive can be reinforced with fibers or a fiber scrim which may include inorganic and/or organic fibers. Suitable fiber scrims may include woven-, non-woven or knit webs or scrims. For example, the fibers in the scrim may include wire, ceramic fiber, glass fiber (for example, fiberglass), and organic fibers (for example, natural and/or synthetic organic fibers).

In some embodiments, the adhesive includes a tackifier. Some exemplary tackifiers include at least one of polyterpene, terpene phenol, rosin esters, and/or rosin acids.

In some embodiments, the peelable adhesive is a flowable adhesive that can be coated onto the backing. In some embodiments, the peelable adhesive is a more solid adhesive as is generally described in, for example, German Patent No. 33 31 016.

In some embodiments, the peelable adhesive has a Tg of between about −125 degrees Celsius and about 20 degrees Celsius, as determined by dynamic mechanical analysis of the tan δ peak value. In some embodiments, the peelable adhesive has a Tg of between about −70 degrees Celsius and about 0 degrees Celsius. In some embodiments, the peelable adhesive has a Tg of between about −60 degrees Celsius and about −20 degrees Celsius. In some embodiments, the peelable adhesive has a Tg of greater than −80 degrees Celsius, greater than −70 degrees Celsius, greater than −60 degrees Celsius, greater than −50 degrees Celsius, greater than −40 degrees Celsius, or great than −30 degrees Celsius. In some embodiments, the peelable adhesive has a Tg of less than 20 degrees Celsius, 10 degrees Celsius, 0 degrees Celsius, −10 degrees Celsius, −20 degrees Celsius, or −30 degrees Celsius.

Some peelable adhesives that can be used in the filters of the present disclosure have a storage modulus of about 300,000 Pa or greater, about 400,000 Pa or greater, about 500,000 Pa or greater, about 1,000,000 Pa or greater at 25° C., as determined by dynamic mechanical analysis. In other embodiments, the adhesive has a storage modulus of 750,000 Pa or less, 500,000 Pa or less, 400,000 Pa or less, 300,000 Pa or less, or 250,000 Pa or less at 25° C., as determined by dynamic mechanical analysis.

In some embodiments, the thickness of the peelable adhesive on at least one of the first or second major surfaces of the core is about 1 μm to about 1 mm.

In some embodiments, adhesion properties of the adhesive can range from 0.1 N/dm to 25 N/dm. In some embodiments, adhesion properties of the adhesive can range from 0.5 N/dm to 10 N/dm. In some embodiments, adhesion properties of the adhesive can range from 1 N/dm to 5 N/dm.

In some embodiments, the peelable adhesive can provide a shear strength of, for example, 1-20 pounds per square inch as measured by ASTM Test Method D3654M-06.

In some embodiments, the peelable adhesives are tailored to achieve peel with no or minimal damage. Exemplary methods and articles for doing so are described in, for example, U.S. Pat. No. 6,835,452, International Publication Nos. WO/2018/039584 and WO/2017/136188, each incorporated herein in their entirety.

Filter(s)

In some embodiments, the filters of the present disclosure further include one or more release liners. The release liner can be, for example, on either or both of the major surfaces of the adhesive layers. The release liner protects the adhesive during manufacturing, transit, and before use. When the user desires to use the filter, the user can peel or remove the release liner to expose the adhesive. Examples of suitable liners include paper, e.g., kraft paper, or polymeric films, e.g., polyethylene, polypropylene or polyester. At least one surface of the liner can be treated with a release agent such as silicone, a fluorochemical, or other low surface energy based release material to provide a release liner. Suitable release liners and methods for treating liners are described in, e.g., U.S. Pat. Nos. 4,472,480, 4,980,443 and 4,736,048. Preferred release liners are fluoroalkyl silicone polycoated paper. The release liners can be printed with lines, brand indicia, or other information.

In some embodiments, the filters of the present disclosure can be removed from a substrate or surface without damage. In particularly advantageous embodiments, the filters can be removed from at least one of painted drywall and wallpaper without damage.

Some filters of the present disclosure have excellent shear strength. Some embodiments of the present disclosure have a shear strength of greater than 1600 minutes as measured according to ASTM D3654-82. Some embodiments of the present disclosure have shear strength of greater than 10,000 minutes as measured according to ASTM D3654-82. Some other embodiments of the present disclosure have shear strength of greater than 100,000 minutes as measured according to ASTM D3654-82.

Some filters of the present disclosure demonstrate a lower 90° Peel Adhesion Strength to make the filter easier to remove. Others demonstrate a higher 90° Peel Adhesion Strength, yet still provide for damage free removal. Some filters of the present disclosure can have a higher 90° Peel Adhesion Strength as to permit handling of the filter by the user without accidental separation. Some embodiments of the present disclosure have a 90° Peel Adhesion Strength between about 50 oz/in²to 400 oz/in². Some embodiments of the present disclosure have a 90° Peel Adhesion Strength between about 100 oz/in²to 300 oz/in². Some embodiments of the present disclosure have a 90° Peel Adhesion Strength between about 150 oz/in² to 250 oz/in².

Some filters of the present disclosure have a tensile strength at break sufficiently high so that the filter will not rupture prior to being removed from an adherend at an angle of 35° or greater.

In some embodiments, the filters of the present disclosure exhibit enhanced conformability to a substrate or surface. In some embodiments, the filters of the present disclosure remain adhered to a textured, rough, or irregular surface for a longer period of time than prior art adhesive filters.

In some embodiments, the filter is substantially optically clear. Some embodiments have a light transmission of at least about 50%. Some embodiments have a light transmission of at least about 75%. Some embodiments have a haze of no greater than 40%. Some embodiments have a haze of no greater than 20%. Both the light transmission and the haze of the filter can be determined using, for example, ASTM D1003-95.

The peelable filters may be coupled to or provided with a frame for optional structural support, as a frame is not necessarily required for the filter to operate. An exemplary frame 300 and peelable filter 330 are depicted in FIG. 6. The frame 300 can assume a variety of forms and is generally configured to surround the perimeter of the filter 330, such that the filter may be attached to elements of the frame. The frame 300 is constructed to robustly support the corresponding filter media 330 when subjected to expected forces of a designated end-use environment (e.g., the frame will maintain its structural integrity during installation to an HVAC system air filter compartment and to normal HVAC system airflow and operation). The frame 300 includes or defines opposing first and second side frame structures 302 and 304 and opposing first and second end frame structures 306 and 308. The side frame structures 302, 304 are generally configured to cover a respective one of the corresponding first and second side edges of the filter 330, whereas the end frame structures 304, 306 are generally configured to attach a respective one of the first and second end edges.

The frame structures 302, 304, 306 and 308 can have any format conducive to use as part of the frame 300 and can be substantially identical or different. In some embodiments, one or more of the frame structures 302, 304, 306, 308 can consist of a single frame member or body. A major portion of the frame 300 may be formed, e.g., by folding of a single frame piece, by the assembling of multiple pieces to each other, and so on. In many embodiments, any one of or all four major frame structures 302, 304, 306 and 308 may each comprise upstream and downstream flanges and inner and outer sidewalls/panels and foldable connections there between. Exemplary frame constructions are described in, for example, U.S. Pat. Nos. 7.503,953 (Sundet et al.), 8,702,829, 8,979,966 (Lise et al.), and International Publication No. 2015/054097 (Castro et al.), all of which are incorporated by reference herein.

The frame 300 can be formed from any material capable of maintaining its structural integrity during use. For example, the frame 300 can be constructed of cardboard, paperboard, plastic (e.g., thermoformed plastic), metal, etc.

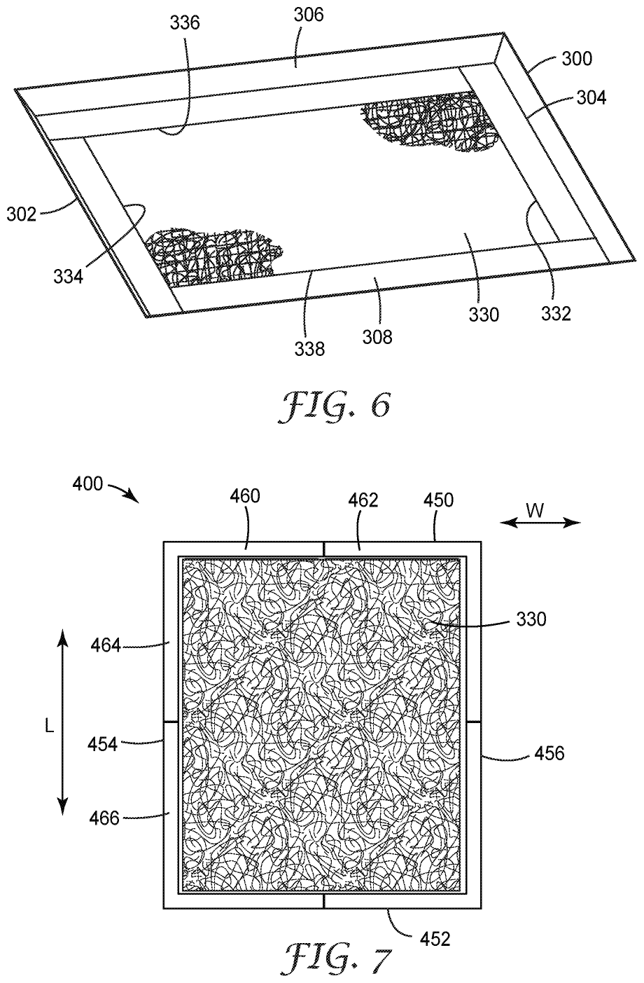

In another embodiment, the peelable filters may be provided with or coupled to an expandable or otherwise dimensionally adjustable framework configured to accommodate different sizes of filter media. FIG. 7 provides one non-limiting representation of an adjustable framework 400 coupled to filter 330, depicted in a non-expanded state. The framework 400 can include multiple components that are slidably connected to another at opposing ends 450, 452 and opposing sides 454, 456. For example, FIG. 7 depicts the framework 400 as including first and second legs 460, 462 at the first end 450. The legs 460, 462 are slidably connected to one another (e.g., the legs 460, 462 can have a complementary U or C-shaped channels, with the dimensions of one leg slightly exceeding the dimensions of the other). In the depicted embodiment, at least a portion of the leg 460 is received in a channel or other similar structure defined at least partially by leg 462, though the opposite construction (e.g., leg 462 is received in leg 460) is equally suitable. Similar constructions can be provided at the opposing end 452 as well as at the opposing sides 454, 456 (e.g., FIG. 7 depicts the framework 400 as including first and second legs 464, 466 at the first side 454).

Other framework 400 constructions may be configured to impede expansion along one of the length and width directions L, W. For example, opposing side 454 could include monolithic or fused leg portions 464, 466, effectively inhibiting the expansion in the length direction L. Alternatively, the first end 450 can include monolithic or fused leg portions 460, 462, effectively inhibiting the expansion in the width direction W.

The framework 400 can optionally include one or more mechanisms or structures that selectively lock the framework 400, and thus the air filter, in a desired expanded state or footprint. The locking device(s) can assume various forms, including mechanical fasteners, hook-and-loop fasteners, adhesives, etc. In other embodiments, the locking devices can be incorporated into the legs of the framework 400 (e.g., the first leg 460 and the second leg 462 can incorporate a complementary tab/slot design whereby a tab carried by the first leg 460 can be inserted into one of a plurality of slots formed along a length of the second leg).

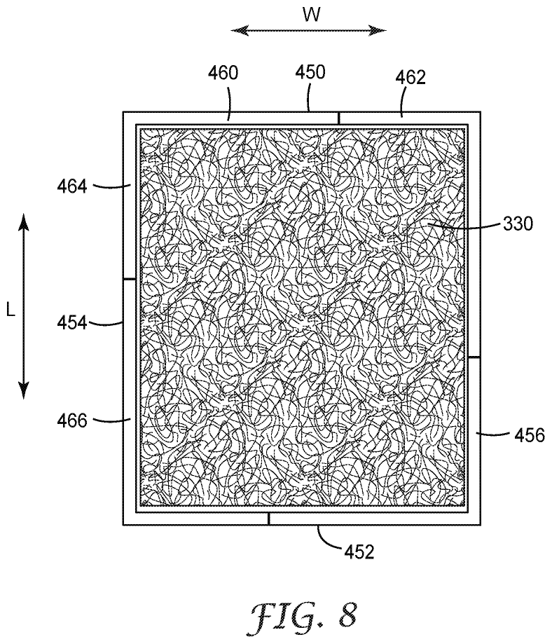

FIG. 8 shows the framework 400 in an expanded state, with the frame have a greater length and width due to the displacement of at least end legs 460, 462 and edge legs 464, 466.

Additional exemplary embodiments of framework 400 and aspects thereof are described in, for example, International Publication No. WO2015/143326 (Zhang et al.) as well as U.S. Pat. Nos. 6,955,702 (Kubokawa et al.), 8,702,820 (Lise et al.), and 9,962,640 (Fox), and U.S. Patent Publication No. 2015/0267927 (Zhang et al.), the disclosure of all of which are incorporated by reference herein.

Method of Making the Peelable Filters Described Herein

The filters described herein can be made in various ways. One embodiment involves disposing an adhesive onto or adjacent to a major surface of a core. In some embodiments, a second adhesive is disposed onto the other major surface of the core.

The adhesive can be disposed on the core in any known way, including, for example, the pressure sensitive adhesive composition can be coated onto a release liner, coated directly onto a core, or formed as a separate layer (e.g., coated onto a release liner) and then laminated to a core. An adhesive can be deposited onto a core with a known deposition method, including, e.g., solvent coating methods, water-borne coating methods, or hot melt coating methods, e.g., knife coating, roll coating, reverse roll coating, gravure coating, wire wound rod coating, slot orifice coating, slot die coating, extrusion coating, or the like.

The core may be selectively consolidated, thinned, or densified using methods described above. The core may be consolidated (e.g., condensed) before, during, or after the adhesive has been disposed on one or both major surfaces. In presently preferred implementations, the consolidation occurs as (i.e., simultaneously or near simultaneously) the adhesive is being been deposited.

In certain implementations, the core is selectively consolidated (i.e., an arranged pattern of recesses is created) using ultrasonic welding. In ultrasonic welding (sometimes referred to as “acoustic welding” or “sonic welding”), two parts to be joined are placed proximate a tool called an ultrasonic “horn” for delivering vibratory energy. These parts (or “workpieces”) are constrained between the horn and an anvil. Oftentimes, the horn is positioned vertically above the workpiece and the anvil. The horn vibrates, typically at 20,000 Hz to 40,000 Hz, transferring energy, typically in the form of frictional heat, under pressure, to the parts. Due to the frictional heat and pressure, a portion of at least one of the parts softens or is melted, thus joining the parts or creating an embossed pattern on the part transferred from either the horn or the anvil.

During the welding process, an alternating current (AC) signal is supplied to a horn stack, which includes a converter, booster, and horn. The converter (also referred to as a “transducer”) receives the AC signal and responds thereto by compressing and expanding at a frequency equal to that of the AC signal. Therefore, acoustic waves travel through the converter to the booster. As the acoustic wavefront propagates through the booster, it is amplified, and is received by the horn. Finally, the wavefront propagates through the horn, and is imparted upon the workpieces, thereby welding them together or creating an embossed pattern on the part, as previously described.

Another type of ultrasonic welding is “continuous ultrasonic welding”. This type of ultrasonic welding is typically used for sealing fabrics and films, or other “web” workpieces, which can be fed through the welding apparatus in a generally continuous manner. In continuous welding, the ultrasonic horn is typically stationary and the part to be welded is moved beneath it. One type of continuous ultrasonic welding uses a rotationally fixed bar horn and a rotating anvil. The workpiece is fed between the bar horn and the anvil. The horn typically extends longitudinally towards the workpiece and the vibrations travel axially along the horn into the workpiece. In another type of continuous ultrasonic welding, the horn is a rotary type, which is cylindrical and rotates about a longitudinal axis. The input vibration is in the axial direction of the horn and the output vibration is in the radial direction of the horn. The horn is placed close to an anvil, which typically is also able to rotate so that the workpiece to be welded passes between the cylindrical surfaces at a linear velocity, which substantially equals the tangential velocity of the cylindrical surfaces. Ultrasonic welding systems are described in U.S. Pat. Nos. 5,976,316 and 7,690,548, each incorporated by reference in their entirety herein.

In other presently preferred implementations, the core is consolidated by pattern embossing. In general, the core is passed through a metal roll that is patterned (e.g., engraved) with raised and depressed areas corresponding to the desired arrangement of recesses, and a solid back-up roll, generally formed of metal or rubber. However, the core can also be fed between two patterned rolls displaying corresponding or alternating engraved areas, as described in U.S. Pat. No. 5,256,231 (Gorman et al.). In either case, it is typical to supply heat to one or more of the rolls so that the core is thermally bonded along the points of pattern contact.

In a presently preferred embodiment, the fibrous webs according to the present invention are thermally embossed with a pattern roll and a patterned back-up roll. In general, the temperature must be such that the fibers of the core are thermally fused at the points of contact without fracturing, or otherwise seriously weakening the core below a useable strength level. In this regard, it is typical to maintain the temperature of the pattern rolls between about 70° C. and 220° C., or between about 85° C. and 180° C. The pattern rolls may be maintained at the same or different temperatures. In addition, the pattern rolls typically contact the nonwoven sheet material at a pressure of from about 17 N/mm to about 150 N/mm, or about 35 N/mm to about 90 N/mm.

In another aspect, the present disclosure provides a method for creating one or more arranged patterns of recesses in a surface. A flow diagram for this process is depicted in FIG. 4. In step 500, a core material (i.e., backing) is provided. The core material can be provided in discrete form or as part of a continuous web of material. In step 510, pattern parameters relating to a first feature pattern are defined to control the initial location, spacing, and size of the recesses on the surface. The first feature pattern can include, but is not limited to, Cartesian grid arrays, hexagonal arrays, and other structured and unstructured arrays. Next, in step 520 the bonding apparatus is moved relative to a first surface of the core along a predetermined path of travel to consolidate the material and create a first portion of the first feature pattern. In other implementations, including those featuring continuous welding or pattern embossing, the surface of the core may be moved relative to the bonding apparatus. The first portion may be a generally horizontal, vertical, diagonal, sinusoidal, spiral or other linear or non-linear series of features, depending on the first feature pattern and the desired orientation of the first feature pattern on the core surface.

This process of creating pattern portions is repeated in Step 530 until the entire first arranged pattern of recesses is created on the desired portion of the core surface. For certain embodiments, the bonding apparatus is offset from the first series according to the first pattern parameters (e.g., pitch) and proceeds to traverse the surface again at the same relative orientation between the apparatus and the core surface to create a second, subsequent portion of the first arranged pattern. For processes relying on continuous web consolidation such as embossing with patterned rolls, the core may continue to be fed through the rolls so that the first pattern portion is continuously created on the desired portion of the entire web. Alternatively, the process 500 may stop at step 520 if a) the pattern is complete and/or; b) no further core material need be consolidated.

Optionally, the process outlined in steps 500-530 may be used to create additional patterns that at least partially overlap with the first arranged pattern, as set out in steps 540-560. The orientation and character of the arranged pattern relative to the surface can be modified, however, between or amongst first and second patterns. For example, the second pattern may consist of channels or recesses having larger dimensions. The modification in the pitch or other parameters between the first and second patterns can cause significant disruption of the recesses created in steps 500-530. In certain implementations, this disruption is caused by overlapping boundary regions of features that exceed an expected cross-sectional dimension (typically diameter). Disruption via substantial overlap between adjacent recesses can modify one or more characteristics of the features including, but not limited to depth, volume, curvature, and cross-sectional dimensions at the base and/or bottom surface. In typical implementations, the core material will take on the appearance of the second arranged pattern.

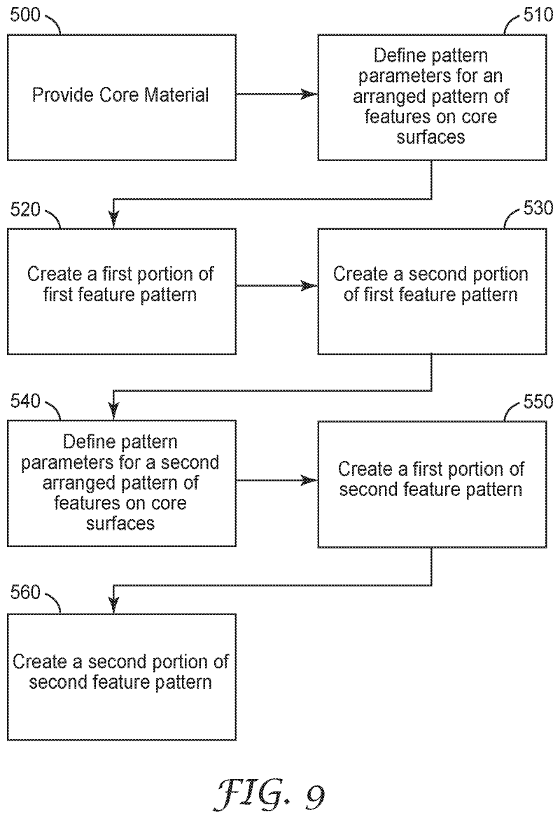

Though the process illustrated in FIG. 9 only outlines the creation of two overlapping feature patterns, one skilled in the art will appreciate that any number of overlapping patterns may be created. For example, it is possible to create of the surface with three, four, six, and eight overlapping arrays and patterns of recesses. In presently preferred circumstances, the orientation of the pattern relative to the surface is modified (e.g., rotated) after the creation of each pattern.

In another aspect, the present disclosure provides a method for creating an additional pattern of arranged recesses in a core material already possessing a first arranged pattern of intrusive features. First, a core material including a first arranged pattern of recesses and two major surfaces is provided. The core may be, for example, the point-bonded film Unipro 275, a spunbond/meltblown/spunbond nonwoven web available from Midwest Filtration LLC (West Chester Township, Ohio). Next, an adhesive can be deposited onto one or both major surfaces of the core. As the adhesive-core interface is being created, the process outlined in steps 500-530 of the method of FIG. 4 may be used to create additional patterns that at least partially overlap with the first arranged pattern as set. The orientation and character of the arranged pattern relative to the surface can be modified between or amongst first and second patterns. For example, the second pattern may consist of channels or recesses having larger dimensions than those elements of the first pattern.

The use of two or more arranged patterns can provide certain advantages to filters of the present disclosure. For instance, a first arranged pattern may be selected to improve the shear holding capability of the article. A second arranged pattern, different from the first pattern, can be selected to improve the performance during peel (e.g., damage reduction and peel force). In one exemplary embodiment, the first arranged pattern comprises discrete circular recesses, and a second pattern includes a plurality of channels extending across the major surfaces of the core.

Discrete filters can be formed from a continuous web of core or adhesive laminated core by a cutting process such as, for example, laser cutting, die cutting, stamping, crimping, or a combination thereof.

Methods of Using the Filters Described Herein

The peelable filters of the present disclosure can be used in various ways. In some embodiments, the filter is applied, attached to, or pressed onto a vent (i.e., register), a fan, a frame, or an air inlet. In this way, the adhesive layer of the filter contacts the adherend. Where a release liner is present, the release liner is removed before the filter is applied, attached to, or pressed into an adherend. In some embodiments, at least a portion of the adherend is wiped with alcohol before the filter is applied, attached to, or pressed into an adherend.

To remove the filter from the adherend, at least a portion of the filter is peeled or stretched away from the adherend. In some embodiments, the angle of stretch is 35° or less. In embodiments where a tab is present, the user can grip the tab and use it to release or remove the filter from the adherend.

The filters can be used in isolation, as one of many articles attached to a surface, or as part of a stack of filters. In the latter implementation, the resulting construction would include a plurality of filters disposed in vertical relation to one another.

Uses

The filter (i.e., those in adhesive tapes or single article) can be provided in any useful form including, e.g., tape, strip, sheet (e.g., perforated sheet), label, roll, web, disc, and kit (e.g., an object for mounting and the adhesive tape used to mount the object). Likewise, multiple filters can be provided in any suitable form including, e.g., tape, strip, sheet (e.g., perforated sheet), label, roll, web, disc, kit, stack, tablet, and combinations thereof in any suitable package including, for example, dispenser, bag, box, and carton. The filters are particularly well suited to being provided in roll form, as the size of the active adhesive areas can be essentially unlimited. A roll allows a user to dispense the needed volume of filter material, with optional an edge of the filter roll attached to the surface of the vent, etc.

Filters can also be initially repositionable and may even be reusable in some core iterations until one of the adhesive layers loses tack. As used herein, “repositionable” means a filter that can be applied to a substrate and then removed and reapplied without distorting, defacing, or destroying the filter, or substrate.

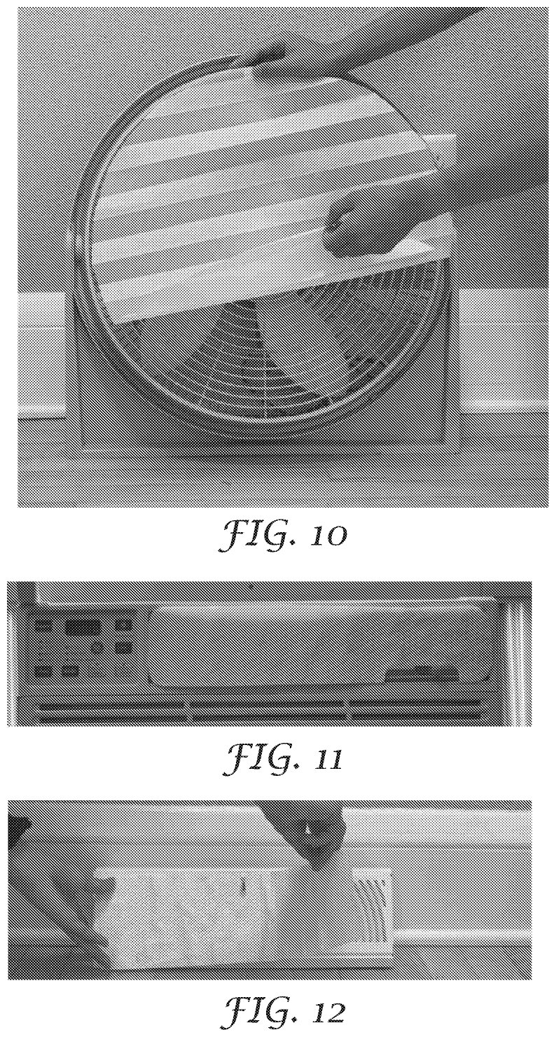

Filters can be placed in the environment of any air handling system, including fans, air conditioners, room air purifiers, air inlet or outlet registers (i.e., vents) of an interior or automotive HVAC system, the filter slot of an HVAC system, or myriad other surfaces positioned in the flow of an air stream. FIG. 10 depicts a user placing a filter of the present disclosure on a fan. FIG. 11 depicts a user placing a filter of the present disclosure on an air conditioner, while FIG. 12 depicts a user placing a filter of the present disclosure on an interior HVAC outlet register.

The filter arrangements disclosed herein may be used with any suitable powered air-handling system. In some embodiments, such an air-handling system may be a heating-ventilation-air-conditioning (HVAC) system, e.g., for a residence (e.g., a single-family home), a commercial or retail building or space, and so on. The term HVAC is used broadly; in various embodiments, an HVAC system may be configured to perform heating, to perform cooling, or to perform either heating or cooling, as desired. In some embodiments, such an HVAC system may be a centralized air-handling system in which air to be handled is collected via multiple air-return inlets (e.g., located in multiple rooms of a building). Such a system often comprises a single, central blower that is arranged to handle relatively large quantities of air from multiple rooms, which air is passed through a centralized air filter. In other embodiments, such an air-handling system may be a so-called mini-split system (often referred to as a “ductless” system) that collects air locally via a single air return and comprise a blower that is designed to recirculate air mainly within a single room. Some buildings may comprise numerous mini-split systems, each dedicated to a specific room or rooms of the building. (A large building may comprise multiple centralized HVAC systems, each serving a different portion or wing of the building.).

In other embodiments, the HVAC system resides in a motor vehicle, as generally exemplified by U.S. Pat. No. 9,120,366 (Hoke et al.). Such an automotive HVAC system may system an air having a blower fan driven by a blower motor. Blower fan can receive either fresh air from an inlet and/or recirculated interior air from an inlet. Blower fan provides a driven airflow to an evaporator core. The driven airflow passes selectably through a heater core. The driven airflow is then selectably output to a floor duct, a panel duct supplying panel registers, and/or a defrost duct supplying defrost registers. Filters of the present disclosure may be placed at the inlet, duct, registers, between the inlet and blower fan, and/or between the blower fan and evaporator core.

In some embodiments the powered air-handling system may be a so-called room air purifier (e.g., that does not possess any significant heating or cooling capability—exemplified in US Publication No. 2019/0107302 (Liu et al.)); in other embodiments the powered air-handling system is not a room air purifier and may be used in association with furnaces, air conditioners, split air conditioners, and powered window air filtration units (e.g., as exemplified in International Publication No. WO201733097 (Gregerson et al.)).

The filters as described herein may also be used placed in ambient airflow, such as on a window screen or other barrier between spaces.

The patents, patent documents, and patent applications cited herein are incorporated by reference in their entirety as if each were individually incorporated by reference. It will be apparent to those of ordinary skill in the art that various changes and modifications may be made without deviating from the inventing concepts set from above. Thus, the scope of the present disclosure should not be limited to the structures described herein. Those having skill in the art will appreciate that many changes may be made to the details of the above-described embodiments and implementations without departing from the underlying principles thereof. Further, various modifications and alterations of the present invention will become apparent to those skilled in the art without departing from the spirit and scope of the invention. The scope of the present application should, therefore, be determined only by the following claims and equivalents thereof.

1. A filter for mounting to a surface within an airflow, the filter comprising:
a first adhesive layer;
a core adjacent the first adhesive layer and defining a perimeter, the core comprising filter media and including first and second major surfaces; and
a first arranged pattern of recesses on at least the first major surface of the core, each recess terminating in a membrane comprising core material and a bottom wall surface; and
an adhesive interface at the bottom wall surface, wherein the adhesive interface comprises contact between the first adhesive layer and the membrane.

2. The filter of claim 1, wherein the core comprises an electret non-woven material.

3. The filter of claim 1, wherein the core includes a sorbent material.

4. The filter of claim 1, wherein the membrane comprises consolidated non-woven material.

5. The filter of claim 1, wherein the filter media includes at least one layer that includes an electret material, and at least one layer that includes a sorbent material.

6. The filter of claim 1, wherein the filter media is self-supporting.

7. The filter of claim 1, wherein the first adhesive layer is secured to one or more surfaces of a frame.

8. The filter of claim 7, wherein the frame has a rectilinear shape.

9. The filter of claim 4, wherein the core material has a void volume, and wherein the void volume of the membrane is substantially less than a void volume of the core material in interstitial spaces between adjacent recesses.

10. The filter of claim 1, wherein the membrane comprises a film of core material.

11. The filter of claim 1, wherein the membranes reside in one more planes substantially parallel to a plane coincident with the first major surface.

12. The filter of claim 1, wherein the first major surface includes interstitial spaces between recesses, wherein contact between the interstitial spaces and the first adhesive layer defines a first core interface, and wherein a Peel Ratio between the recess interface and the first core interface is at least 1.15:1.

13. The filter of claim 1, further comprising a second adhesive layer adjacent the second major surface.

14. The filter of claim 1, wherein the arranged pattern of recesses has a density of at least 20 recesses per square centimeter.

15. The filter of claim 1, wherein the first adhesive layer includes a peelable adhesive.

16. The filter of claim 1, wherein the adhesive is ultrasonically bonded to the membrane.

17. A filter for mounting to a surface, the filter comprising:
a first adhesive layer comprising a first peelable adhesive composition:
a core adjacent the first adhesive layer and defining a perimeter, the core comprising porous, electret filter media and including first and second major surfaces; and
a first arranged pattern of recesses on at least the first major surface of the core, each recess terminating in a membrane comprising core material,
wherein the first peelable adhesive composition is at least partially within the pores of each membrane.

18. The filter of claim 17, wherein the core material has a void volume, and wherein the first adhesive composition at least partially infiltrates the void volume of the membrane.

19. The filter of claim 17, wherein the article includes an available bond area on a major surface of the first adhesive layer of between about 10% and about 90%.

20. A roll including the filter of claim 17.
